(19) United States
(12) Patent Application Publication
(10) Pub. No.: US 2007/0014000 A1
(43) Pub. Date: Jan. 18, 2007

(54) AUTOMATIC MICROSCOPE AND METHOD FOR TRUE-COLOR IMAGE

(75) Inventors: Andreas Nolte, Rosdorf (DE); Lutz Hoering, Aalen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Jena GmbH

(21) Appl. No.: 11/427,260

(22) Filed: Jun. 28, 2006

(30) Foreign Application Priority Data
Jun. 29, 2005 (DE) 10 2005 031 104.0

(51) Int. Cl. G02B 21/00

(52) U.S. Cl. 359/368

(57) ABSTRACT

The object in an automatic microscope and a method for true-color image reproduction in automatic microscopes is to provide a monitor image which corresponds to the optical impression of an eyepiece image with respect to color and contrast. According to the invention, the spectral distribution of a light source which can be controlled with respect to brightness and/or color temperature is determined upon initial startup, and the intensity of spectral components is associated with control parameters for the light source. Measurements of the spectral distribution of the light source when operating the microscope and of the ratio of the intensity of spectral components to the control parameters which is determined upon initial startup are used for the regulated control of the light source. Further, the spectral distribution of the monitor image is determined upon initial startup, and the measured spectral distributions of the light source and of the monitor image are compared with the spectral distributions of the light source and of the monitor image determined upon initial startup. Spectral deviations determined in the distributions are compensated by adapting the spectral distribution of the monitor image to the spectral distribution of the light source.

### CROSS-REFERENCE TO RELATED APPLICATION

This application claims priority of German Application No. 10 2005 031 104.0, filed Jun. 29, 2005, the complete disclosure of which is hereby incorporated by reference.

### BACKGROUND OF THE INVENTION

a) Field of the Invention

The invention is directed to an automatic microscope and to a method for true-color image reproduction in automatic microscopes which contain a light source which is controllable with respect to brightness and/or color temperature, imaging optics, an image receiver for receiving images, and a monitor for displaying received images and which are connected to an evaluating and controlling computer.

b) Object and Summary of the Invention

The requirements for the optical components of automated microscope systems which are geared to the dimensions of the sample geometry or to the geometry of the different sample carriers and to the exclusive use of optoelectronic sensors are completely different from those that were usually applied to conventional microscopes heretofore.

Microscope systems of the kind mentioned above should have a substantially compact optical construction. For this reason, light-emitting semiconductor components (LEDs) in particular are provided as illumination components. An illumination field which is spatially expanded and therefore adaptable to the source can be formed by these light-emitting semiconductor components, in contrast to the light sources otherwise commonly used, e.g., high-pressure lamps or halogen lamps, so that expenditure on optics can be considerably reduced.

While conventional microscopes and microscope systems usually use illumination systems which, in the absence of additional optical components, cannot be controlled with respect to color temperature and can be controlled only to a limited extent with respect to brightness, light-emitting semiconductor components (LEDs) offer the additional advantage that such components can be controlled individually within the illumination field (DE 203 04 412 U1).

Light sources can be constructed in which white light can be generated by superimposing different wavelengths (DE 103 14 125 A1).

However, problems arise in these automatic microscope systems when the brightness, color temperature, and color selection of the illumination field, the exposure times of the camera system, and the color reproduction of a monitor must be adjusted in such a way that an observer receives an optical impression that is comparable to an eyepiece image with respect to color and contrast.

Calibration routines commonly used heretofore for image recording, such as white matching in which a definition of the color “white 3200K” is carried out by selecting a pixel with the corresponding color temperature and automatically adapting the image information to this color temperature, or black matching with manual definition of a pixel without color information and automatic adaptation of the image information and elimination of background noise, are not capable of calibrating and controlling the entire electronic image-generating chain (illumination, filter, camera, graphics card, screen).

Therefore, it is the object of the invention to provide a monitor image which corresponds to the optical impression of an eyepiece image with respect to color and contrast.

According to the invention, this object is met by an automatic microscope which contains a light source that is controllable with respect to brightness and/or color temperature by means of a light source control for the purpose of true-color image reproduction.

Further, the automatic microscope for true-color image reproduction contains illumination optics, a first spectrally measuring device which communicates with a first control unit and which serves to measure the spectral distribution of the light emitted by the light source, an object holder, imaging optics, an electronic image receiver which is connected to a monitor for displaying received images, and an evaluating and controlling computer which is connected to the first control unit and to the monitor and which is provided for adjusting the brightness and/or the color temperature of the light source by means of the first control unit and by means of the light source control connected to the latter.

In a preferred construction, the light source is constructed as an illumination field comprising individual semiconductor components which emit in different wavelengths and which can be controlled individually with respect to intensity by the light source control so that an adjustment of the brightness and/or the color temperature of the illumination field can be carried out.

Further, when the spectral distribution of the monitor image is advantageously acquired by a second spectrally measuring device, the evaluating and controlling computer can be provided for comparing the spectral distribution of the monitor image with the determined spectral distribution of the light emitted by the illumination field in order to tune the brightness and/or the color temperature of the illumination field and of the monitor to one another for true-color reproduction of an object on the monitor.

A spectrometer that can be swiveled into the optical beam path is suitable as a spectrally measuring device, or the electronic image receiver serves as a device of this kind.

Another object of the invention is a method for true-color image reproduction in automatic microscopes which contain a light source that is controllable with respect to brightness and/or color temperature, an image receiver for receiving images, and a monitor for displaying received images and which are connected to an evaluating and controlling computer. This method has the following method steps: determination of the spectral distribution of the light source upon initial startup and association of the intensity of spectral components with control parameters for the light source, measurement of the spectral distribution of the light source when operating the microscope, and regulated control of the light source based on the measured spectral distribution of the light source and on the ratio of the intensity of spectral components to the control parameters for the light source, which ratio is determined upon initial startup.

The method according to the invention can preferably have the following additional method steps: determination of the spectral distribution of the monitor image upon initial startup, measurement of the spectral distribution of the monitor image when operating the microscope, and comparison of the measured spectral distributions of the light source and of the monitor image with the spectral distributions of the light source and of the monitor image determined upon initial startup in order to determine spectral deviations in the distributions, and compensation of determined spectral deviations by adapting the spectral distribution of the monitor image to the spectral distribution of the light source.

Adaptation of the spectral distribution of the monitor image to the spectral distribution of the light source is advantageously carried out by means of a graphics card control in the evaluating and controlling computer.

Adjustment of the brightness and/or of the color temperature of a light source comprising individual semiconductor components emitting in different wavelengths can be carried out by means of discrete control of the intensity of the semiconductor components that combine to form an illumination field. Either the applied voltage or the supplied current serves as control parameter.

It is also advantageous when information is sent when exceeding a determined deviation from the ratio of the intensity and the performance parameters serving for control, which ratio is determined upon initial startup.

Overall, by means of spectral measurements and a light source whose brightness, color temperature and color selection can be adjusted automatically and which can be compensated with respect to degradation, the invention ensures full control over the electronic image-generating chain. A regulating algorithm which also includes the color reproduction on the monitor can be generated.

The invention will be described more fully in the following with reference to the schematic drawings.

### BRIEF DESCRIPTION OF THE DRAWINGS

In the drawings:

FIG. 1 shows a block diagram of components of an automatic microscope which has a first spectrally measuring device for the illumination light emitted by an illumination field; and

FIG. 2 shows a block diagram of components of an automatic microscope which contains another spectrally measuring device for the monitor image.

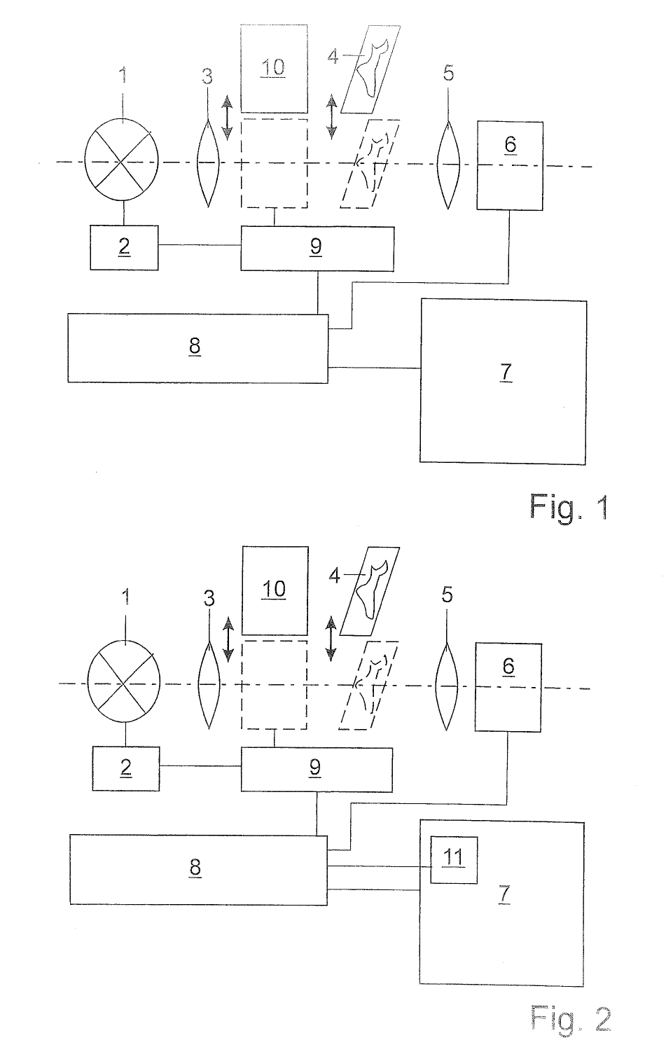

According to the invention, an automatic microscope corresponding to FIG. 1 contains, as components, a light source 1 with a light source control 2 and illumination optics 3 downstream of the latter. An object 4 which is to be examined and for which a holder, not shown, is provided is imaged via imaging optics 5 on an electronic image receiver 6 which is connected to a monitor 7 for displaying received images.

By means of an evaluating and controlling computer 8 which is connected to a first control unit 9 and to the monitor 7, a light source adjustment can be carried out via the first control unit 9 and via the light source control 2 which is connected to the latter.

The light emitted by the light source 1 is directed directly to the electronic image receiver 6 upon initial startup so that, depending on the control parameters (applied voltage or supplied current) for the light source, a voltage-current intensity diagram of the light source 1 is prepared by means of the intensity measured on the image receiver 6. When the image receiver 6 is constructed as a color camera, the voltage-current intensity diagram can be prepared for the three spectral components. The voltage-current intensity diagram is used by the evaluating and controlling computer 8 as a lookup table (LUT) for regulating the illumination intensity of the light source 1 by means of the voltage or the current.

The aging of the light source 1, which can be detected from the deviation of the measured values in the voltage-current intensity diagram, can be tracked in an advantageous manner so that it can be guaranteed that the intensity is maintained constant by means of a regulating algorithm. When a determined deviation is exceeded in the voltage-current intensity diagram, the evaluating and controlling computer 8 can send information about wear occurring in the light source 1.

In a preferred construction of the invention, an illumination field comprising individual semiconductor components emitting in different wavelengths is used rather than an individual source, e.g., an individual LED, as a light source 1 so that mixed colors can be produced by superimposing individual colors in the object plane. The semiconductor components (LEDs) are controllable individually with respect to intensity by means of the light source control 2 which is constructed as a multiple-channel LED controller (one channel per color) so that the brightness and the color temperature of the illumination field can be adjusted.

Different types of illumination control are provided according to the invention.

In a first construction, the light generated by the illumination field is directed directly to the electronic image receiver 6 upon initial startup for each individual color so that a voltage-current intensity diagram can be prepared for the individual spectral components depending on the control parameters voltage or current for the light source 1 by means of the intensity measured by the image receiver 6. The pair of values from the voltage-current intensity diagram is used by the evaluating and controlling computer 8 as a lookup table (LUT) for regulating the spectral illumination intensity by means of the voltage or the current.

Any color temperatures of the visible spectrum can be generated and the total brightness adjusted by controlling the individual semiconductor components. According to the invention, a lookup table (LUT) is also prepared upon initial startup for the color temperatures which are generated corresponding to the control.

Also, the aging of the light source 1 which is constructed as an illumination field can be tracked based on the deviation of the measured intensities for the individual colors from those in the voltage-current intensity diagram.

In a second construction, a spectrally measuring device 10, e.g., a grating spectrometer, is provided for an illumination control. This spectrally measuring device 10 can be arranged in the optical beam path O—O and can detect the entire spectral distribution of the illumination field generated by a corresponding control. The illumination is regulated and monitored by the evaluating and controlling computer 8 by comparing with a detection of the control-dependent spectral distribution of the illumination field which is carried out during the initial startup and stored as a lookup table (LUT).

When another spectrally measuring device 11 for the monitor image is added to the components contained in FIG. 1, the substantial color-determining components of the electronic image-generating chain of a microscope can be controlled and monitored, which is very important for maintaining a uniform color impression of microscope recordings on a conventional color monitor over a long period of time.

By means of the additional spectrally measuring device 11, particularly a spectrometer, which is arranged at a location on the image screen surface of the monitor 7, the spectral distribution of the monitor image is also detected so that the color information from the monitor image can also be transmitted to the evaluating and controlling computer 8. As was already carried out for the light source 1, a calibration used by the evaluating and controlling computer 8 as a lookup table is also prepared for the monitor when first starting up the automatic microscope.

Spectral deviations caused by optical and electronic elements in the imaging chain between the light source 1 and the monitor 7 are determined by comparing the spectral distribution of the direct light emitted by the light source 1 with the spectral distribution of the monitor image, whereupon color matching can be carried out by means of the graphics card of the evaluating and controlling computer 8 in that the determined spectral deviations are compensated by adapting the spectral distribution of the monitor image to the spectral distribution of the light source 1.

The two spectra of the camera and monitor can be matched to one another by comparing the two lookup tables for the spectra of the illumination and of the monitor and by direct control of the graphics card.

While the foregoing description and drawings represent the present invention, it will be obvious to those skilled in the art that various changes may be made therein without departing from the true spirit and scope of the present invention.

What is claimed is:

1. An automatic microscope comprising:
a controllable light source; and
a light source control for controlling said light source for true-color image reproduction.

2. The automatic microscope according to claim 1 which, for the purpose of true-color image reproduction, further containing illumination optics, a first spectrally measuring device which communicates with a first control unit and which serves to measure the spectral distribution of the light emitted by the light source, an object holder, imaging optics, an electronic image receiver which is connected to a monitor for displaying received images, and an evaluating and controlling computer which is connected to the first control unit and to the monitor and which is provided for adjusting the brightness and/or the color temperature of the light source by the first control unit and by the light source control connected to the latter.

3. The automatic microscope according to claim 2, wherein the light source is constructed as an illumination field comprising individual semiconductor components which emit in different wavelengths and which can be controlled with respect to intensity individually and/or in groups of the same kind by the light source control so that an adjustment of the brightness and/or the color temperature of the illumination field can be carried out.

4. The automatic microscope according to claim 2, wherein a second spectrally measuring device is provided which detects the spectral distribution of the monitor image.

5. The automatic microscope according to claim 4, wherein the evaluating and controlling computer is provided for comparing the spectral distribution of the monitor image with the determined spectral distribution of the light emitted by the illumination field in order to tune the brightness and/or the color temperature of the illumination field and of the monitor to one another for true-color reproduction of an object on the monitor.

6. The automatic microscope according to claim 2, wherein the first spectrally measuring device is a spectrometer which can be swiveled into the optical beam path.

7. The automatic microscope according to claim 2, wherein the electronic image receiver serves as a first spectrally measuring device.

8. A method for true-color image reproduction in automatic microscopes, which contain a light source that is controllable with respect to brightness and/or color temperature, imaging optics, an image receiver for receiving images, and a monitor for displaying received images and which are connected to an evaluating and controlling computer, said method comprising the steps of:
determining the spectral distribution of the light source upon initial startup and associating the intensity of spectral components with control parameters for the light source;
measuring the spectral distribution of the light source when operating the microscope; and
controlling the light source in a regulated manner based on the measured spectral distribution of the light source and on the ratio of the intensity of spectral components to the control parameters for the light source;, which ratio is predetermined upon initial startup.

9. The method according to claim 8, containing the following additional method steps: determination of the spectral distribution of the monitor image upon initial startup, measurement of the spectral distribution of the monitor image when operating the microscope, and comparison of the measured spectral distributions of the light source and of the monitor image with the spectral distributions of the light source and of the monitor image determined upon initial startup in order to determine spectral deviations in the distributions, and compensation of determined spectral deviations by adapting the spectral distribution of the monitor image to the spectral distribution of the light source.

10. The method according to claim 9, wherein the adaptation of the spectral distribution of the monitor image to the spectral distribution of the light source is carried out by means of a graphics card control in the evaluating and controlling computer.

11. The method according to claim 8, wherein an adjustment of the brightness and/or of the color temperature of a light source comprising individual semiconductor components emitting in different wavelengths is carried out by means of discrete control of the intensity of the semiconductor components that are combined to form an illumination field.

12. The method according to claim 11, wherein an applied voltage or supplied current is provided as a control parameter for the individual semiconductor components emitting in different wavelengths.

13. The method according to claim 8, wherein information is sent when exceeding a determined deviation from the ratio of the intensity and the control parameters serving for control, which ratio is determined upon initial startup.
